(19) United States
(12) Patent Application Publication
(10) Pub. No.: US 2025/0059057 A1
(43) Pub. Date: Feb. 20, 2025

(54) SYSTEMS AND METHODS FOR PRODUCING RENEWABLE AMMONIA

(71) Applicant: REMO ENERGY, INC., Boston, MA (US)

(72) Inventors: Guido RADAELLI, Pleasant Hill, CA (US); Srinivas R. VUDDAGIRI, Davis, CA (US); Scott RACKEY, Boston, MA (US)

(21) Appl. No.: 18/721,096

(22) PCT Filed: Dec. 15, 2022
(86) PCT No.: PCT/US2022/081624

§ 371 Date: Jun. 17, 2024

Related U.S. Application Data
(60) Provisional application No. 63/290,945, filed on Dec. 17, 2021.
(60) Provisional application No. 63/328,632, filed on Apr. 7, 2022.

(51) Int. Cl. C01C 1/02

(52) U.S. Cl. CPC C01C 1/026

(57) ABSTRACT

Methods for producing renewable ammonia are disclosed. Systems for implementing the methods are also disclosed.

### BACKGROUND

### Technical Field

The present disclosure generally relates to methods for producing renewable ammonia and systems related to the same.

### Description of the Related Art

Approximately 175 million metric tons of ammonia (NH₃) were produced globally in 2018, of which approximately 88% was used as fertilizer. The remainder is primarily used as a precursor in the production of nitrogenous compounds. Ammonia is typically produced using the Haber-Bosch process that includes an exothermic gas-phase reaction between hydrogen (H₂) and nitrogen (N₂) at around 450° C. and high pressure (about 100 bar). The H₂ for the process is typically produced from fossil fuels, e.g., by steam reforming of natural gas, partial oxidation of methane, or coal gasification. By some measures, production of ammonia and its derivatives accounts for approximately 3-5% of global greenhouse gas (GHG) emissions. Therefore, there is a critical need for sustainable production of ammonia (i.e., with reduced or negligible GHG emissions). The present disclosure provides this and related technical advances.

### BRIEF SUMMARY

Current technology for production of ammonia is not well suited for sustainable production (e.g., from hydrogen produced by electrolysis). World-scale ammonia plants can produce up to approximately 5,000 tons per day and are situated in areas of cheap natural gas with the product being transported considerable distances. In contrast, the systems described herein are designed to produce up to about 100,000 tons per year and be situated in regions with cheap renewable power (e.g., from solar or wind), ideally close to the end consumer of the product.

The inventors of the present disclosure recognized that simply scaling down the traditional Haber-Bosch process and using H₂ produced from electrolysis of water would not be a practical or ideal solution for a number of reasons. First, the rate of ammonia production from such a design would not be able to be turned up and down to match the variable nature of renewable energy production from wind and solar (i.e., load following) because of the nature of the compressors required to achieve high operating pressures of the traditional process. Second, operation at these high pressures (greater than about 80 bar) requires a complex reactor unit with a cold shell (where the catalyst does not directly contact the pressure vessel) and expensive specialized materials that are not weakened by hydrogen embrittlement, hot hydrogen attack, and nitriding. These materials are not practical or economical at smaller scale.

Counter-intuitively, the systems described herein operate at lower pressure (less than about 80 bar, less than about 60 bar, or less than about 40 bar). At these pressures, the reaction N₂+3H₂→2NH₃ is not as favored as it would be at higher pressure. However, this disadvantage is more than compensated by other advantages. Namely, the systems described herein can operate at a pressure that more closely matches the outlet pressure of an electrolysis unit, which eliminates a compressor that would be needed to reach reaction pressures in excess of 80 bar. This eliminated compressor would typically have been a multi-stage centrifugal compressor, which is costly and prevents the process from being rapidly turned up and down. Second, lower pressure allows for a simpler reactor design (e.g., hot shell axial reactors), which is considerably less expensive than a conventional cold-shell ammonia synthesis converter. At the lower pressure, the synthesis reactor can also use a pseudo-isothermal design. For example, a tubular reactor made of conventional materials (e.g., carbon steel or stainless steel) can be used without incurring metallurgy degradation due to hot hydrogen attack. Alternatively, a plate-cooled reactor can also be used for the ammonia synthesis at low pressure. Furthermore, lower pressures reduce the severity of hydrogen embrittlement, hot hydrogen attack, and nitriding, allowing for lower cost materials of construction for the entire hot section of the ammonia synthesis loop. Furthermore, a single de-oxygenation reactor can be used to purify the reactant gas streams, eliminating the shift reactors, CO₂ removal, and methanation units of traditional designs based on hydrocarbon reforming. Furthermore, the ammonia product can be condensed at temperatures less than about −20° C., which can be achieved with a closed-loop refrigeration cycle using a screw compressor rather than a multi-stage centrifugal compressor for the traditional open-loop designs.

Synergistically, the modules of the systems described herein work to achieve unexpected benefits. The systems can be modular (i.e., designed once and built and deployed several times), matching the scale and achieving the economics required by renewable power production, electrolyzer output, and ammonia consumption. Accordingly, in one embodiment is provided a method for producing ammonia (NH₃), the method comprising:
a. producing hydrogen (H₂) using electrolysis;
b. enriching nitrogen (N₂) to a concentration of at least about 95%;
c. combining and de-oxygenating the H₂ and the N₂ to produce a feedstock stream; and
d. synthesizing NH₃ from the feedstock stream in a synthesis reactor at a pressure below about 80 bar.

In some embodiments, the method further comprises condensing NH₃ at a temperature less than about −20° C., for example less than about −25° C.

In different embodiments, the NH₃ is condensed using a screw compressor that uses ammonia as a cooling medium.

In other aspects, the NH₃ is condensed using an economizer. For example, in some instances the condensed ammonia is heated by cooling a refrigerant stream.

In other different embodiments, the NH₃ is condensed using a closed-loop refrigeration module. For example, the refrigeration module uses propane or propylene as a refrigeration fluid in certain embodiments.

In other of the foregoing embodiments, the method further comprises storing the condensed NH₃ at ambient temperature and a pressure between about 15 bar and about 25 bar.

In more of the foregoing embodiments, the method further comprises recirculating non-reacted H₂ and N₂ to the synthesis reactor. For example, the recirculated H₂ and N₂ may be pressurized to a pressure of the synthesis reactor using a single-stage compressor.

In more embodiments, the electrolysis is powered using renewable energy.

In certain embodiments, the N₂ is enriched from air. In different embodiments, the N₂ is enriched using pressure swing adsorption (PSA). In some other embodiments the N₂ is enriched using an air separation unit (ASU). In other different embodiments, the N₂ is enriched using a membrane.

In some embodiments, the N₂ comprises between about 1% and about 2% oxygen (O₂) prior to de-oxygenation.

In certain aspects, the H₂ and/or the N₂ are de-oxygenated by reacting H₂ with O₂.

In various embodiments, the electrolyzer that is used to produce the H₂ is integrated with a de-oxygenation module.

In still more embodiments, the H₂ and N₂ are de-oxygenated in a single reactor. In some of these embodiments, the H₂ and/or the N₂ are de-oxygenated using a catalyst comprising a platinum group metal. In other embodiments, the H₂ and/or the N₂ are de-oxygenated at a temperature of less than about 400° C.

In different embodiments, the synthesis reactor has a hot shell. For example, in some embodiments a catalyst is in direct contact with a pressure vessel. In other embodiments, the pressure vessel can safely contain hydrogen at the equilibrium temperature of the ammonia synthesis reaction.

In some more embodiments the synthesis reactor is an axial reactor. For example, in some embodiments gas flows downward relative to the catalyst bed.

In other different embodiments, the synthesis reactor is a tubular reactor. For example, the synthesis reactor may have a catalyst in a shell or in a plurality of tubes. In other embodiments, the synthesis reactor uses a cooling medium which is a gas feed to the reactor, hot oil, Boiler Feed Water (BFW), or steam.

In some other embodiments the synthesis reactor is a plate-cooled reactor with a catalyst contained in a shell. For example, in some embodiments the synthesis reactor uses a cooling medium which is a gas feed to the reactor, hot oil, Boiler Feed Water (BFW), or steam.

In other embodiments, the synthesis reactor comprises a catalyst having a pellet diameter of less than about 3 millimeters (mm). For example, in some embodiments the catalyst comprises iron oxide, such as an iron oxide comprising wustite or magnetite. In other embodiments, the catalyst comprises Ruthenium or Cobalt. In still different embodiments, the catalyst is nanostructured and has nano-tubes or nano-fibers.

In some embodiments the method can produce NH₃ at an approximately constant ratio of power consumed per unit mass of NH₃ produced. For example, the ratio can be approximately constant when the rate of NH₃ production is reduced by at least about 30%, at least about 50%, or at least about 70% from a maximum production rate.

In different embodiments, a production rate of NH₃ can be increased or decreased by at least about 10% per minute.

In other aspects, wherein the synthesis reactor is operated at a pressure of less than about 60 bar.

In some other embodiments the synthesis reactor is operated at a pressure of about 40 bar.

In still more embodiments, the present disclosure provides a system for producing ammonia (NH₃), the system comprising:
a. an air separation module that is configured to separate air into a first stream comprising oxygen (O₂) and a second stream comprising nitrogen (N₂);
b. an electrolysis module that is configured to use electrical power to split water (H₂O) into a third stream comprising O₂ and a fourth stream comprising hydrogen (H₂);
c. a de-oxygenation module that is configured to remove oxygen from the second stream, the fourth stream, or any combination thereof; and
d. an ammonia synthesis module that is configured to react the N₂ from the second stream with the H₂ from the fourth stream to produce NH₃, wherein the ammonia synthesis module comprises a synthesis reactor configured to operate at a pressure below about 80 bar.

In some embodiments, the system further comprises a condensation module configured to condense NH₃ at a temperature less than about −20° C. In some embodiments, the condensation module uses a screw compressor that uses ammonia as a cooling medium. In other embodiments, the condensation module includes an economizer. For example, the condensed ammonia may heated by cooling a refrigerant stream. In other of the foregoing embodiments, the condensation module comprises a closed-loop refrigeration unit.

In some embodiments, the system further comprises a storage module configured to store the condensed NH₃ at ambient temperature and a pressure between about 15 and about 25 bar.

In some different embodiments, the system further comprises a single-stage compressor configured to recirculate non-reacted H₂ and N₂ to the synthesis reactor.

In some embodiments the electrolysis module is powered using renewable energy.

In other embodiments the air separation module uses pressure swing adsorption (PSA). In some other embodiments the air separation module uses a membrane. In more different embodiments, the air separation module produces N₂ comprising between about 1% and about 2% oxygen (O₂).

In some embodiments the de-oxygenation module is configured to react H₂ with O₂.

In other embodiments, the electrolysis module is integrated with the de-oxygenation module.

In some embodiments the de-oxygenation module comprises a single reactor. In some other embodiments the de-oxygenation module includes a catalyst comprising a platinum group metal.

In different embodiments, the de-oxygenation module is configured to operate at a temperature of less than about 400° C.

In some embodiments the synthesis reactor has a hot shell. For example, in some such embodiments a catalyst is in direct contact with a pressure vessel. In exemplary embodiments, the pressure vessel can safely contain hydrogen at the equilibrium temperature of the ammonia synthesis reaction.

In some embodiments the synthesis reactor is an axial reactor. In some of these examples gas flows downward relative to the catalyst bed.

In other embodiments the synthesis reactor comprises a catalyst having a pellet diameter of less than about 3 millimeters (mm). In some of these embodiments, the catalyst comprises iron oxide, for example an iron oxide comprising wustite or magnetite.

In different embodiments, the system can produce NH₃ at an approximately constant ratio of power consumed per unit mass of NH₃ produced, for example a ratio that is approximately constant when the rate of NH₃ production is reduced by at least about 30%, at least about 50%, or at least about 70% from a maximum production rate.

In some embodiments a production rate of NH₃ can be increased or decreased by at least about 10% per minute.

In some different embodiments the system consumes less than about 50 megawatts (MW) of electrical power per year.

In yet other embodiments the system has a capacity for producing NH₃ of at least about 1,000 metric tons per year.

In still more embodiments, the system has a capacity for producing NH₃ of less than about 100,000 metric tons per year.

In different embodiments, the system further comprises a boost compressor which increases a pressure of the second stream and/or the fourth stream.

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter within this disclosure are contemplated as being part of the inventive subject matter disclosed herein.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE FIGURES

FIG. 1 shows an example of the systems and methods described herein.

### DETAILED DESCRIPTION

The production of synthetic ammonia and its derivatives has been one of the key enablers of the global development of intensive agriculture. It is estimated that, without synthetic nitrogen fertilizers, the world would require three to four times more arable land to sustain current food production requirements.

The commercial production of synthetic ammonia was enabled by the discovery of iron-based catalysts capable of reacting hydrogen with nitrogen at industrially viable conditions, usually at pressures of a few hundred atmospheres and temperatures above 400° C. In this traditional process, the hydrogen feed is generated via steam reforming of hydrocarbons, natural gas being the most common hydrocarbon utilized. The nitrogen is introduced into the process in the form of air and the oxygen is combusted with a fraction of the hydrocarbons to generate part of the heat required by steam reforming.

The basic process described above has not changed in any significant way since the first commercial production of synthetic ammonia many decades ago. Over the years, the technology development has proceeded in two main directions: (a) a continuous optimization to achieve an incrementally improved utilization of the energy contained in the hydrocarbon feed via more and more sophisticated heat and mass integration; and (b) a continuous scale-up effort to increase the maximum single train size to the current world scale capacities above 3,500 metric tons per day (MTD).

The commercial manufacturing processes that have resulted from these two development strategies cannot be easily adapted and deployed for the production of renewable ammonia, especially if the hydrogen feed is generated via water electrolysis powered with renewable energy. In fact, ammonia production from renewable power does not include a hydrocarbon feed and is typically very distributed in nature.

In contrast, the process described herein produces hydrogen (H₂) using electrolysis, enriches nitrogen (N₂) to a concentration of at least about 95%; de-oxygenates and combines the H₂ and the N₂ to produce a feedstock stream; and synthesizes NH₃ from the feedstock stream in a synthesis reactor at a pressure below about 80 bar.

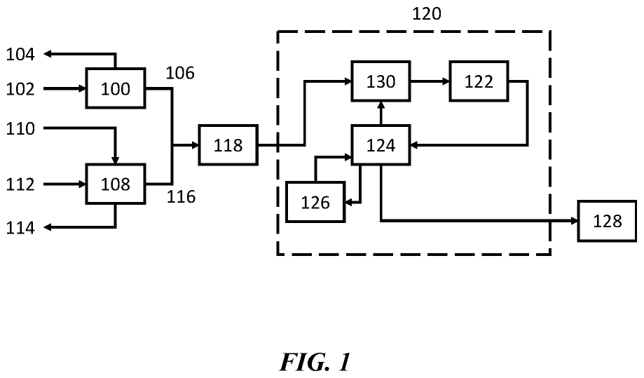

With reference to FIG. 1, an embodiment of the system described herein for producing ammonia (NH₃) can include an air separation module 100 that is configured to separate air 102 into a first stream comprising oxygen (O₂) 104 and a second stream comprising nitrogen (N₂) 106. The system can include an electrolysis module 108 that is configured to use electrical power 110 to split water (H₂O) 112 into a third stream comprising O₂ 114 and a fourth stream comprising hydrogen (H₂) 116. The system can further include a de-oxygenation module 118 that is configured to remove oxygen from the second stream and/or the fourth stream and an ammonia synthesis module 120 that is configured to react the N₂ from the second stream with the H₂ from the fourth stream to produce NH₃. The ammonia synthesis module comprises a synthesis reactor 122 configured to operate at a pressure below about 80 bar.

The system can further comprise a condensation module 124 configured to condense NH₃ at a temperature less than about −20° C. The condensation module can use a screw compressor 126 that uses ammonia as a cooling medium (e.g., evaporates and recompresses the ammonia). A storage module 128 can be configured to store the condensed NH₃ at a pressure between about 15 and about 25 bar and ambient temperature. In some cases, a single-stage compressor 130 is configured to recirculate non-reacted H₂ and N₂ to the synthesis reactor 122.

In some cases, the pressure at the electrolyzer outlet is less than the pressure of the ammonia synthesis module. In such cases, a boost compressor can be used to increase the pressure prior to the ammonia synthesis module. The pressure at the electrolyzer outlet can be any suitable pressure, such as about 15 bar, about 20 bar, about 25 bar, about 30 bar, about 35 bar, about 40 bar, about 50 bar, about 60 bar, or about 80 bar. In some instances, the outlet pressure of the electrolyzer is between about 20 and about 30 bar. The electrolyzer can be a polymer electrolyte membrane (PEM) or alkaline electrolyzer.

The hydrogen required for the ammonia synthesis can be provided by an electrolyzer, which utilizes electric power to convert water into hydrogen and oxygen. The ammonia product can be considered renewable if a portion of the power fed to the electrolyzer originated entirely or partly from a renewable source or carbon free source such as nuclear power, or if such power is sourced from the grid or any other source in combination with the acquisition of renewable power credits or similar financial instruments. For the systems and methods described herein, the electrolyzer does not require a hydrogen purification unit to remove oxygen impurities, as the final oxygen removal is performed in the de-oxygenation (aka, hydrogenation) reactor. However, in some embodiments a hydrogen purification unit may be beneficial.

The nitrogen required for the ammonia synthesis can be generated from the separation of nitrogen from air or from the enrichment of nitrogen in air. For example, such enrichment can be obtained via the use of the membranes, which can produce a stream with nitrogen in excess of 80% mol. Alternatively, a pressure swing adsorber (PSA) or vacuum PSA (VPSA) can also be utilized to produce a nitrogen rich stream with a nitrogen concentration in excess of 80% mol. Alternatively, an Air Separation Unit (ASU) can also be utilized to separate nitrogen from air via air liquefaction and/or distillation. Any other means of separating nitrogen from air or enriching nitrogen in air can be utilized for this process having the nitrogen concentration in the resulting stream above 80% mol.

In some cases, the nitrogen concentration is about 80%, about 85%, about 90%, about 95%, about 97%, about 99%, about 99.5%, about 99.9%, about 99.95%, or about 99.99%. In some instances, the nitrogen concentration is at least about 80%, at least about 85%, at least about 90%, at least about 95%, at least about 97%, at least about 99%, at least about 99.5%, at least about 99.9%, at least about 99.95%, or at least about 99.99%.

The hydrogen and nitrogen streams can be mixed together to produce the raw synthesis gas (“syngas”) stream, which contains oxygen in addition to hydrogen, nitrogen and other minor impurities. As used herein, the term “syngas” describes a gas stream that is used to make ammonia. The syngas used herein does not typically contain appreciable amounts of carbon monoxide (CO). The raw syngas is pre-heated to the inlet temperature required by the de-oxygenation reactor, usually a temperature between ambient and 300° C. depending on the exact type and composition of the hydrogenation catalyst utilized. The pre-heating can be performed either with an external source of energy (for example, an electric heater) or by recovering heat from an appropriate stream within the process via heat exchange.

The de-oxygenation reactor can be a fixed bed reactor that employs a standard hydrogenation catalyst, such as the ones utilized for hydrogen purification from electrolytic cells. For example, a catalyst containing platinum or palladium is conventionally utilized for these applications. The design of the reactor can be single-stage adiabatic, for example, a vessel containing one type of catalyst. Alternatively, it can be a multi-stage adiabatic reactor, for example with multiple sections of catalyst (either the same catalyst or optionally different catalysts optimized for each section of the reactor), in series with heat exchangers in between each catalyst bed. It can also bean isothermal or pseudo-isothermal reactor, including any means of providing heat exchange inside the catalytic bed. In some embodiments the reactor can also be a combination of such designs.

The effluent from the de-oxygenation reactor can be the wet syngas stream, which contains hydrogen, nitrogen, minor impurities and the water generated by the combination of hydrogen and oxygen in the reactor. The wet syngas stream can be cooled to ambient temperature via heat exchange with other process streams, water cooling, air cooling, direct quench with water or even below ambient temperature by heat exchange with another cold fluid (such as ammonia or any ammonia containing stream), or any combination thereof. The wet syngas stream can be dried.

Water can be removed from the wet syngas. In some cases, the syngas is dried in a dehydration unit, which is operated in a Temperature Swing Adsorption (TSA) cycle. Two or more vessels can be filled with sorbent material (such as molecular sieve) that has a high affinity to water. One or more vessels can be operated in adsorption mode where the water in the wet syngas is adsorbed by the sorbent while the gas stream flows through the bed. Once the sorbent is saturated with water, the vessels can be switched to the regeneration mode. While some vessels are operated in adsorption mode, the remaining are operated in regeneration mode where the purge gas stream is heated to a suitable temperature (usually between 15° and 350° C.) and passed over the saturated sorbent material to evaporate the water contained in the sorbent. The location of the purge extraction in the synthesis loop can vary depending on the specific design and operating conditions. For example, the purge can be extracted from the effluent downstream of the primary condenser or from the dry syngas produced by the dehydration unit itself.

The dry syngas stream can be fed to the ammonia synthesis reactor without the risk of damaging or poisoning the ammonia synthesis and/or catalyst, which can be sensitive to oxygenated compounds. Several designs can be adopted for the ammonia synthesis reactor. In some cases, a multistage adiabatic reactor with multiple layers of catalyst can be separated by heat exchangers. The catalyst beds can be contained in separate vessels or in a single vessel and the heat exchangers can be external to the vessels or contained inside them. The catalytic beds can have an axial, axial-radial or radial design. In some cases, the reactor is an axial reactor.

In some cases, the reactor is a pseudo-isothermal reactor with one or more layers of catalyst that feature heat exchange elements inserted in the catalytic bed, such as tubes or plates. The catalyst beds can be contained in separate vessels or in a single vessel and can have an axial, axial-radial or radial design. In some cases, the reactor is an axial reactor.

The synthesis reactor used in the methods described herein can have a hot shell. In a hot shell reactor, the catalyst is in direct contact with a pressure vessel. This can be achieved here because of the operation of the ammonia synthesis module at a lower pressure (and lower temperature). This is in contrast to the more costly cold shell reactors that separate the catalyst from the pressure vessel. The pressure vessel can safely contain hydrogen at the equilibrium temperature of the ammonia synthesis reaction. The synthesis reactor can be an axial reactor. An axial reactor can flow gas downward relative to the catalyst bed.

The synthesis reactor used in the methods described herein can include heat exchange elements (e.g., tubes or plates) made of conventional metallurgies (e.g., carbon or stainless steel) placed in direct contact with the catalyst. This can be achieved because of the operation of the ammonia synthesis module at a lower pressure (and lower temperature).

The ammonia synthesis catalyst can comprise iron oxide. In some cases, the iron oxide comprises wustite or magnetite. The catalyst can contain any suitable promoters, diluents, binders, excipients, and can be formed into any suitable form. In some cases, the catalyst has a pellet diameter of about 10 millimeters (mm), about 7 mm, about 5 mm, about 3 mm, about 2 mm, or about 1 mm. In some cases, the catalyst has a pellet diameter of less than about 10 millimeters (mm), less than about 7 mm, less than about 5 mm, less than about 3 mm, less than about 2 mm, or less than about 1 mm. In contrast, world-scale designs typically use radial reactors in order to achieve a high cross section. The reactor designs described herein are uniquely available to use these small catalyst forms.

The ammonia synthesis catalyst can also be based on formulations optimized for operation at low pressure. For example, the catalyst may contain very active materials such as ruthenium (Ru) or promoters such as cobalt (Co). These low pressure catalysts can also be based on nanostructures with very large active surface areas, such as nano-tubes or nano-fibers (for example, nanostructures obtained by the precipitation of lanthanum oxides).

The synthesis of NH₃ can be done at any suitable pressure. In some cases, the synthesis reactor is operated at a pressure of about 100 bar, about 80 bar, about 70 bar, about 60 bar, about 50 bar, about 40 bar, or about 30 bar. In some cases, the synthesis reactor is operated at a pressure of less than about 100 bar, less than about 80 bar, less than about 70 bar, less than about 60 bar, less than about 50 bar, less than about 40 bar, or less than about 30 bar.

The ammonia synthesis reactor effluent can be cooled via heat exchange with another process stream or with an external stream, such as water or air, or any combination thereof. Additional cooling can be provided with direct injection of cold ammonia into the reactor effluent (i.e., direct quenching) or via an ammonia chiller (e.g., indirect cooling generated by ammonia evaporation with the vapors).

Depending on the operating pressure and temperature of the primary condenser of the ammonia synthesis, a portion—ranging between 0% and 80%—of the ammonia contained in the reactor effluent condenses and forms the liquid stream of anhydrous ammonia, which is separated from the syngas stream in the gas-liquid separator.

The pressure of the anhydrous ammonia can be reduced in one or more adiabatic expansions, usually performed with suitably designed valves and gas-liquid separators. In some embodiments, the pressure reduction may take place in an expander or any combination of expander and adiabatic flashes. The final anhydrous ammonia product can be stored at (i) either ambient temperature and a pressure above the corresponding vapor pressure (usually 15-20 atmospheres), or (ii) at ambient pressure under cryogenic conditions (−33° C.), or (iii) any intermediate pressure between ambient and 15-20 atmospheres.

The recovery module can be capable of recovering the NH₃ and utilize an economizer. An economizer can be used in cases where the final ammonia product is stored and/or utilized at a temperature higher than the condensation temperature adopted for the synthesis loop (e.g., ambient temperature). In the economizer, the condensed ammonia product stream is heated by further cooling the refrigerant stream.

The process can be operated with a recycle loop. For example, by recirculating non-reacted H₂ and N₂ to the synthesis reactor. The recirculated H₂ and N₂ can be pressurized to a pressure of the synthesis reactor using a single-stage compressor.

In some cases, the only inputs in this process are air, water and electric power and the end products are aqueous and anhydrous ammonia, which can be generated in any combination depending on the design and operating parameters selected for the process.

The method can produce NH₃ at an approximately constant ratio of power consumed per unit mass of NH₃ produced. The ratio is approximately constant when the rate of NH₃ production is reduced by at least about 20%, at least about 50%, or at least about 70% from a maximum production rate.

The process can be rapidly turned up or down (e.g., to accommodate variable production of renewable energy). The production rate of NH₃ can be increased or decreased by at least about 10% per minute.

The system can consume about 300 megawatts (MW), about 200 MW, about 100 MW, about 80 MW, about 80 MW, about 60 MW, about 40 MW, about 20 MW, or about 10 MW of electrical power per year. In some instances, the system consumes less than about 300 megawatts (MW), less than about 200 MW, less than about 100 MW, less than about 80 MW, less than about 80 MW, less than about 60 MW, less than about 40 MW, less than about 20 MW, or less than about 10 MW of electrical power per year.

The systems described herein can have any suitable capacity for producing NH₃. In some cases, the system has a capacity for producing NH₃ of about 1,000, about 5,000, about 10,000, about 50,000, or about 100,000 metric tons per year. In some embodiments, the system has a capacity for producing NH₃ of at least about 1,000, at least about 5,000, at least about 10,000, at least about 50,000, or at least about 100,000 metric tons per year. In some cases, the system has a capacity for producing NH₃ of at most about 1,000, at most about 5,000, at most about 10,000, at most about 50,000, or at most about 100,000 metric tons per year.

In summary, the systems and methods described herein are designed for scale, discontinuous operation (e.g., which allows for use of non-standard units) and process integration. Without limitation, certain design factors minimize the specific capex ($/metric ton) at a less than 200 metric tons per day capacity (equivalent to less than 100 megawatts). These design parameters would be either technically or economically unviable at a traditional scale of greater than 1,000 metric tons per day.

First, low pressure operation can approximately match the delivery pressure of a polymer electrolyte membrane (PEM) electrolyzer with no need for custom-made 2-barrel syngas compressor (obviating a major contributor to the capex in a traditional design). In some cases, either no compressor or a smaller and simpler compressor can be used. This choice would be impossible at greater than 1,000 metric tons per day (MTD) because the volumetric circulation flow in the synthesis loop would be too great.

Second, use of cheap and simple hot shell axial reactors eliminates the need for multi-million cold shell converters with internal radial cartridges and interchangers. This choice would not be practical at greater than about 1,000 MTD because (i) the operating pressure would prevent the use of a hot shell (due to high equilibrium T), and (ii) the axial design would require an impossibly large vessel diameter (due to the cross section necessary to accommodate the circulation flow).

Third, the circulator can be a cheap (e.g., Sundyne™) machine with no need for custom-made centrifugal stage integrated with the syngas compressor. This factor is not possible at >1,000 MTD because standard machines are not sufficiently large and would not be able to handle the operating pressure.

Fourth, the systems and methods described herein can use a refrigeration screw compressor. This eliminates the need for custom-made multi-stage centrifugal machine. This choice is not practical at >1,000 MTD because these machines are not sufficiently large. In fact, adopting them would require two of them at 100 MW.

Fifth, in some cases, there is no heat recovery anywhere in the system, including in the synthesis loop. This can eliminate the need for a steam system (which is a major capex contributor).

Sixth, the systems and methods described herein have the option to generate and store ammonia at about 20-bar and ambient temperature. This can result in a capex and opex savings versus generating cryogenic ammonia. This design feature is impossible at >1,000 MTD because storage and logistics for such volumes is only viable with cryo-ammonia.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

U.S. Provisional Patent Application Nos. 63/290,945, filed Dec. 17, 2021, and 63/328,632, filed Apr. 7, 2022, to which the present application claims priority, are hereby incorporated herein by reference in their entirety.

1. A method for producing ammonia (NH₃), the method comprising:
a. providing hydrogen (H₂);
b. enriching nitrogen (N₂) to a concentration of at least about 95%;
c. combining and de-oxygenating the H₂ and the N₂ to produce a feedstock stream; and
d. synthesizing NH₃ from the feedstock stream in a synthesis reactor at a pressure below about 80 bar.

2. The method of claim 1, further comprising condensing NH₃ at a temperature less than about −20° C.

3. The method of claim 2, wherein the NH₃ is condensed at a temperature less than about −25° C.

4. The method of claim 2, wherein the NH₃ is condensed using a screw compressor that uses ammonia as a cooling medium.

5. (canceled)

6. The method of claim 4, wherein condensed ammonia is heated by cooling a refrigerant stream.

7. The method of claim 2, wherein the NH₃ is condensed using a closed-loop refrigeration module.

8. The method of claim 7, wherein the refrigeration module uses propane or propylene as a refrigeration fluid.

9. The method of claim 2, further comprising storing the condensed NH₃ at ambient temperature and a pressure between about 15 bar and about 25 bar.

10. The method of claim 2, further comprising recirculating non-reacted H₂ and N₂ to the synthesis reactor.

11. The method of claim 10, wherein the recirculated H₂ and N₂ are pressurized to a pressure of the synthesis reactor using a single-stage compressor.

12. The method of claim 1, wherein the electrolysis is powered using renewable energy.

13. (canceled)

14. The method of claim 1, wherein the N₂ is enriched using pressure swing adsorption (PSA).

15.-19. (canceled)

20. The method of claim 1, wherein the H₂ and N₂ are de-oxygenated in a single reactor.

21. (canceled)

22. The method of claim 1, wherein the H₂ and/or the N₂ are de-oxygenated at a temperature of less than about 400° C.

23.-25. (canceled)

26. The method of claim 1, wherein the synthesis reactor is an axial reactor.

27. (canceled)

28. The method of claim 1, wherein the synthesis reactor is a tubular reactor.

29.-37. (canceled)

38. The method of claim 1, wherein the method can produce NH₃ at an approximately constant ratio of power consumed per unit mass of NH₃ produced.

39. (canceled)

40. (canceled)

41. The method of claim 1, wherein the synthesis reactor is operated at a pressure of less than about 60 bar.

42. The method of claim 1, wherein the synthesis reactor is operated at a pressure of about 40 bar.

43. A system for producing ammonia (NH₃), the system comprising:
e. an air separation module that is configured to separate air into a first stream comprising oxygen (O₂) and a second stream comprising nitrogen (N₂);
f. an electrolysis module that is configured to use electrical power to split water (H₂O) into a third stream comprising O₂ and a fourth stream comprising hydrogen (H₂);
g. a de-oxygenation module that is configured to remove oxygen from the second stream, the fourth stream, or any combination thereof; and
h. an ammonia synthesis module that is configured to react the N₂ from the second stream with the H₂ from the fourth stream to produce NH₃, wherein the ammonia synthesis module comprises a synthesis reactor configured to operate at a pressure below about 80 bar.

44.-74. (canceled)
